(19) United States
(12) Patent Application Publication
(10) Pub. No.: US 2025/0048112 A1
(43) Pub. Date: Feb. 6, 2025

(54) METHOD FOR ASSISTING A USER OF A TERMINAL IN DECIDING TO APPROVE A COMMUNICATION, OR NOT, CORRESPONDING DECISION-MAKING ASSIST SYSTEM AND COMPUTER PROGRAM

(71) Applicant: Orange, Issy-les-Moulineaux (FR)

(72) Inventors: Baptiste HEMERY, Chantillon Cedex (FR); Fabrice JEANNE, Chantillon Cedex (FR)

(21) Appl. No.: 18/782,627

(22) Filed: Jul. 24, 2024

(30) Foreign Application Priority Data
Jul. 31, 2023 (FR) 2308271

(51) Int. Cl. H04W 12/60

(52) U.S. Cl. CPC H04W 12/66

(57) ABSTRACT

A decision-making assist method for a user of a first terminal receiving a communication request originating from a second terminal, the user of the second terminal being unknown to the user of the first terminal. The method includes determining a trust score of the user of the second terminal and a trust deviation, the trust deviation providing information on a reliability of the trust score. The trust score and the trust deviation are determined from a list including at least one user of a third terminal to which the second terminal has already transmitted a communication request, the at least one user of the third terminal belonging to at least one user community.

### CROSS-REFERENCE TO RELATED APPLICATION

This application claims foreign priority to French Application No. 2308271, filed Jul. 31, 2023. The contents of the French application are incorporated by reference herein in its entirety.

### BACKGROUND

### Field

The present development relates to securing exchanges between communication terminals (for example a mobile phone, a tablet, a computer, etc.) within a communication or transaction network, for example an IP network (standing for “Internet Protocol” in English), or USSD (standing for “Unstructured Supplementary Service Data” in English).

By “exchange”, it should be understood any type of relationship between users of communication terminals. In other words, the development could apply to any contexts implementing telecommunications and financial transactions, incoming or outgoing, for which it is possible to establish a social relationship between users. Such exchanges include for example: mobile payments, bank transfers, telecommunications such as calls, SMSs (standing for “Short Message Service” in English), video conferences, etc.

### Description of the Related Technology

The IP network is the carrier of several services and applications. Some telecommunication operators use this network in particular to support their different service offerings.

Indeed, many offers are based on the principle of a relationship of two users of terminals connected to the Internet in order to establish a communication or a financial transaction between these users.

These services and applications allow establishing exchanges between users. These exchanges are occasions for fraudsters to attempt to divert the exchanges for their profit by incidentally coming into contact with their targets (for example by sending messages, making widely disseminated calls, etc.) or by pretending to be a trusted relationship (for example during a targeted scam, diversion or identity theft attempt, etc.).

Some users might also commit an error and unintentionally initiate an exchange to an undesired contact (for example an input error or a fraudulent link). Hence, it is essential for the security of the user to warn him/her in case of detection of an exchange deemed to be risky and protect him/her by preventing, where necessary, such a relationship.

There are already several solutions for protecting these users, with more or less effectiveness. The simplest one is the use of “black lists” or “white lists” representing a set of risky, or trustful, identifiers (like for example: telephone numbers, WhatsApp numbers, MSISDN (standing for “Mobile Station International Subscriber Directory Number” in English), IBAN (standing for “International Bank Account Number” in English), etc.) allowing rapidly checking up the presence of an identifier on this list and acting accordingly. These lists exist but should be updated on a regular basis, therefore, they are not comprehensive.

For example, in the context of mobile payment, some fraudsters change their phone number on a regular basis, making it almost impossible to maintain and disseminate an up-to-date “black” list. Thus, the use of such a list is therefore often limited to fraud sources that are clearly identified on a global or country level, for example using the AML/CFT list system (standing for “Anti Money Laundering/Countering the Financing of Terrorism” in English). These lists are managed on a national or international level by companies, (inter)governmental or financial institutions (for example the anti-money laundering and terrorism financing inter-governmental organization or FATF (standing for “Financial Action Task Force” in English) but also by the service providers themselves which seek to identify fraudster users).

The set-up of a trust list or “white” list is an effective solution but with a relatively limited use: it is generally based on the construction of a list of recurrent contacts (for example, derived from the address or call book) or it is constructed locally after verification and validation of its content. These lists are often personal, relatively reduced in number of contacts (for example restricted to the contacts of the user), not comprehensive and relatively difficult to keep up-to-date.

More evolved systems for analyzing the behavior or the habits of the user allow detecting an input error but are ineffective for example when initiating a payment towards an unknown addressee. Nevertheless, they are complementary to the solutions proposed before.

Another known solution of the prior art suggests the set-up of a trust/risk indicator based on the assessment of an inter-individual social distance upon any transaction. This method is based on the implementation and the exploitation of community detection algorithms taking account of the social and time dimensions of the exchanges.

One amongst the drawbacks of this methods results from the application of the social distance computing method on a new user individual of the service. His/Her social profile on the transactional network is similar to that of an abusive user as it does not belong/is not integrated to the social structure of the transactional graph extracted from a community detection. Thus, when the latter comes into relationship with a contact, the latter could be identified and displayed as potentially abusive for his/her interlocutor, because the computation of a social distance will be impossible (infinite distance) on the basis of the history of the exchanges of the service (which still does not exist or is still barely dense). This could be detrimental to the initiator of the exchange (new legitimate user) and to the operator of the service.

Thus, the method proposed in the prior art has a limitation as it might generate false positives with new users who, because of the absence of any use history, might be considered as potential abusive users which might be detrimental to both the operator of the service and to the clients of this operator.

Hence, there is a need for a technique for assisting in making a decision on abusive users of a transactional system that is effective as of the first communications without sharing personal data.

### SUMMARY

Hence, an object of the development is a decision-making assist method for a user of a first terminal receiving a communication request originating from a second terminal, the user of the second terminal being unknown to said user of the first terminal (i.e. the user of the second terminal still not having transmitted any communication request to the user of the first terminal). The decision-making assist method comprises determining a trust score of the user of the second terminal and a trust deviation, said trust deviation providing information on a reliability of said trust score, said trust score and said trust deviation being determined from a list comprising at least one user of a third terminal to which the second terminal has already transmitted a communication request. The at least one user of the third terminal belongs to at least one user community.

Like for the exploitation of the detection of communities, the system is based on the principle according to which a “legitimate” communication query preferably relates two individuals having a social proximity that can be quantified. Conversely, a communication query involving an interlocutor deemed to be not reliable should be detectable through the analysis of a group structure: ephemeral bonds and groups, one-way relationships, low exchange frequency, short lifespan and barely stable structure, and therefore conclude on the absence of any social proximity.

A social proximity may be relational (a member of my family, a friend, a colleague, etc.), of interest (a group, a club, commercial, etc.), geographical (a merchant, a neighbor, etc.) but also a combination of these elements. The past and future communications reinforce or loosen the relationships/bonds between the individuals of these user communities which evolve over time and are therefore at the basis of the construction of user communities of interests that can be identified from the service data. In general, the communities thus formed are larger, more complete, more stable over time than the different aforementioned lists and are shared between all of the members of a community and are no longer individuals.

The proposed method allows regulating the status of the user by progressive integration thereof to the network of user communities which is enhanced through a “normal” use of the service over time. Still on the basis of a computation of the inter-individual social distance or on a community detection method, the proposed system allows qualifying the use of the service made by any individual and outputting a real-time and evolving trust indicator, which can be anonymously exploited later on by the service provider.

In one variant, the list comprises three users of respectively three terminals to which the second terminal has already transmitted a communication request.

In one variant, the determination of the trust score and of the trust deviation comprises selecting at least one pair of users in said list.

In one variant, the determination of the trust score comprises, for each pair of users, computing a minimum intercommunity distance, said minimum intercommunity distance being determined from community sets to which the users of said pair belong, said trust score corresponding to an average of the minimum intercommunity distances of the pairs.

In one variant, if the users of one pair have one community in common, the minimum intercommunity distance of said pair is zero.

In one variant, if the users of one pair have no community in common, the minimum intercommunity distance of said pair is at least equal to 1.

In one variant, the trust deviation corresponds to a standard deviation of the minimum intercommunity distances of the pairs.

In one variant, the trust score corresponds to a cardinality of a union of user communities to which the three users of the list belong.

In one variant, the trust deviation corresponds to the trust score from which is subtracted an average of the cardinalities of unions of the user communities to which the three users of the list belong.

Another object of the development relates to a decision-making assist system for a user of a first terminal receiving a communication request originating from a second terminal, the user of the second terminal being unknown to said user of the first terminal (i.e. the user of the second terminal still not having transmitted any communication request to the user of the first terminal). The decision-making assist system comprises a computing device and a communication base, said computing device and said communication base being configured to determine a trust score of the user of the second terminal and a trust deviation, said trust deviation providing information on a reliability of said trust score. The trust score and the trust deviation are determined from a list comprising at least one user of a third terminal to which the second terminal has already transmitted a communication request, the at least one user of the third terminal belonging to at least one user community.

In one variant, the computing device is adapted to transmit the trust score and the trust deviation to the first terminal.

In one variant, the system comprises an application server, said application server being configured to process said trust score and said trust deviation and to send the result of said processing to the first terminal.

Another object of the development relates to a computer program comprising program code instructions for the execution of the steps of the decision-making assist method according to the development, when said program is executed by a processor.

Another object of the development relates to a computer-readable recording medium on which a computer program is recorded comprising program code instructions for the execution of a decision-making assist method according to the development, when said program is executed by a processor.

### BRIEF DESCRIPTION OF THE DRAWINGS

FIG. 1 illustrates an example of a communication network implementing a decision-making assist method according to the embodiments of the development;

FIG. 2 illustrates an example of a terminal configured to emit a communication request in the communication network of FIG. 1;

FIG. 3 illustrates an example of a history of communications between different users of the communication network of FIG. 1;

FIG. 4 shows a graph illustrating the history of communications of FIG. 3;

FIG. 5 shows a table listing communities to which the different users of the communication network of FIG. 1 belong;

FIG. 6 shows the graph of FIG. 4 associated with the list of the communities of FIG. 5;

FIG. 7 shows a community graph obtained from a data association of FIG. 6;

FIG. 8 shows a matrix for storing the minimum distance between communities of FIG. 7;

FIG. 9 shows a table corresponding to the table of FIG. 5, with additional columns;

FIG. 10 illustrates an example of a terminal configured to receive a communication request via the communication network of FIG. 1;

FIG. 11 shows the different steps of a decision-making assist method according to a first embodiment of the development;

FIG. 12 shows the different steps of a decision-making assist method according to a second embodiment of the development;

FIG. 13 illustrates, in a detailed manner, a decision-making assist system used in the network of FIG. 1.

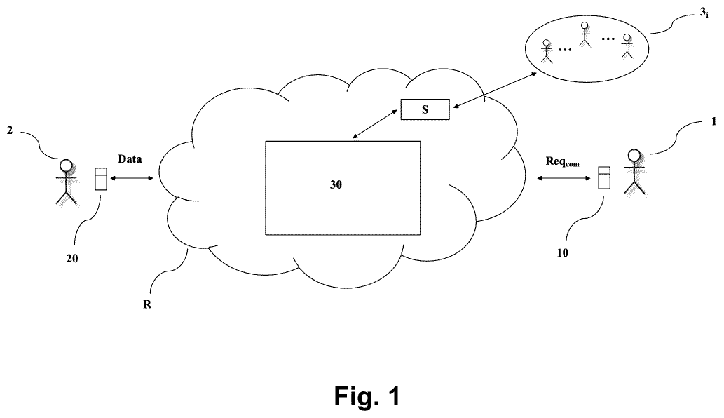

FIG. 1 shows a communication network R for exchanging data between a terminal 10 of a user 1 and a terminal 20 of a user 2.

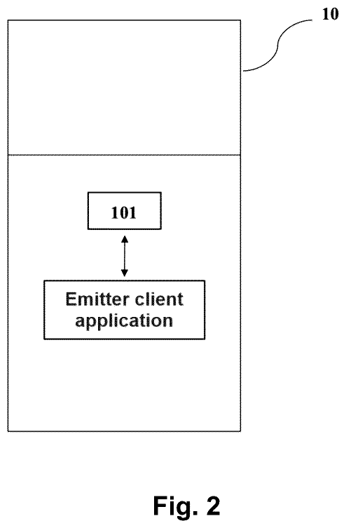

The terminal 10 of the user 1 is adapted to transmit a communication request Req_{com} to the terminal 20 in order to establish communication with the user 2. FIG. 2 details the structure of such a terminal 10.

The terminal 10 is herein a smart terminal, or “smartphone” in English, adapted to implement software applications. Thus, the terminal 10 comprises an interface module 101 and an emitter client application. The interface module 101 enables the user 1 to transmit a command for sending a communication request Req_{com} to the terminal 20. Typically, the interface module 101 is a keyboard of the terminal 10. Alternatively, the interface module 101 could be a voice command. The emitter client application is adapted to generate and transmit to the communication network R the communication request Req_{com} from the send command originating from the interface module 101 of the terminal 10.

As illustrated in FIG. 1, the communication network R comprises a decision-making assist system 30 and a supervision device S. The decision-making assist system 30 is able to receive a query for determining a trust score Sconf associated with the user 1 and a trust deviation Deltaconf. Such a query is derived from the communication request Req_{com}. The trust score Sconf provides information on the trust to be granted on the user 1. The trust deviation Deltaconf provides information on the reliability of said trust score Sconf. In response to this determination query, the decision-making assist system 30 is adapted to transmit to the terminal 20 data Data associated with the determination of the trust score and of the trust deviation Deltaconf.

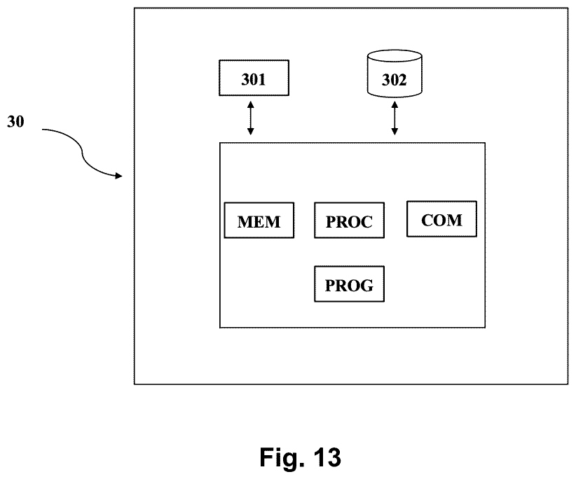

FIG. 13 illustrates, in a more detailed manner, the decision-making assist system 30. This decision-making assist system 30 comprises at least one processor PROC and at least one memory MEM. More particularly, the system 30 is provided, according to one embodiment, with the hardware architecture of a computer. The memory MEM forms an information medium in accordance with the development, i.e. readable by the processor PROC and on which a computer program PROG in accordance with the development is recorded. The program PROG includes instructions for carrying out steps of a method in accordance with the development, when the program PROG is executed by the processor PROC. In particular, the program PROG defines the functional modules of the system 30, which control the hardware elements of the latter.

As illustrated in FIG. 13, the system 30 comprises a communication device COM configured to communicate in particular with the supervision device S and the terminals 10 and 20 of FIG. 1. There is no limitation on the nature of the communication interfaces between these devices, which could implement any protocol known to a person skilled in the art.

The decision-making assist system 30 further comprises:
a computing device 301;
a communication base 302.

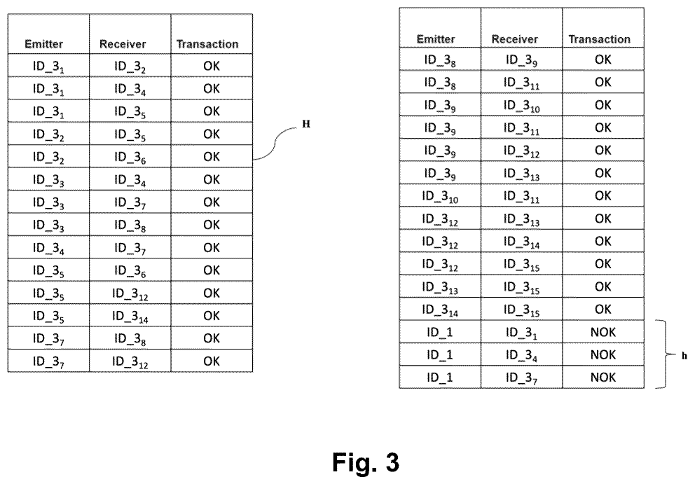

The computing device 301 is adapted to compute the trust score Sconf and the trust deviation Deltaconf from information stored in the communication base 302. More particularly, the communication base 302 stores a history H of communication requests between different user terminals of the communication network. FIG. 3 illustrates an example of such a history between, for example, fifteen users 3₁ to 3₁₅, the terminal(s) of each of these users being able to serve as an emitter or receiver of a communication request. These users are respectively referenced in the history H from an identifier ID_3₁ to ID_3₁₅. In a particular embodiment that is not illustrated herein, the used identifier is a MSISDN identifier (standing for “Mobile Station International Subscriber Directory Number” in English). When a communication request transmitted by a terminal of these users is approved by a terminal of another one of these users, a transaction is passed. Thus, the history H lists the completed transactions, so-called OK transactions, and the non-completed transactions, so-called NOK transactions. In the example of FIG. 3, all transactions between the contact users 3₁ to 3₁₅ have been completed.

The history H also lists the communication requests having been transmitted by the terminal 10 of the user 1. The user 1 is referenced starting from the identifier ID_1. No transaction is validated for this user 1, since the latter is not known to the different users 3₁ to 3₁₅. Thus, it is possible to establish a list h of users to whom the user 1 has transmitted beforehand a communication request via his/her terminal 10.

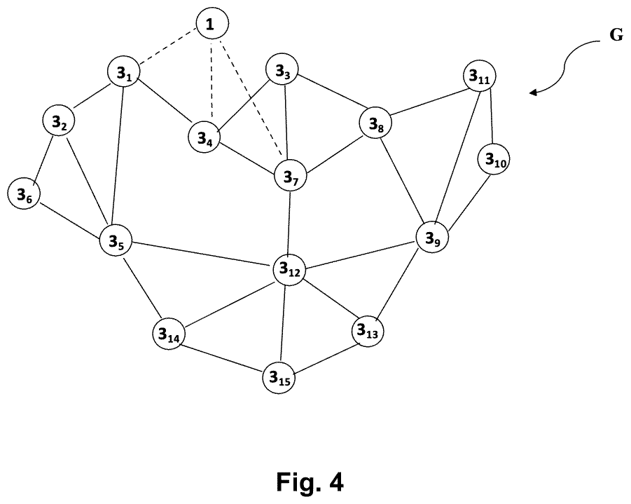

FIG. 4 shows a graph G illustrating the history of communications of FIG. 3. In this graph G, each user 3₁ to 3₁₅ represents a circular node. The transactions OK between the nodes are represented by solid lines.

In this FIG. 4, it is possible to deduce the following information:
a first user 31 has already performed at least one transaction with a second user 32, a fourth user 34 and a fifth user 35;
the second user 32 has already performed at least one transaction with the first user 31, the fifth user 35 and a sixth user 36;
a third user 33 has already performed at least one transaction with a fourth user 34, a seventh user 37 and an eighth user 38;
the fourth user 34 has already performed at least one transaction with the first user 31, a third user 33 and the seventh user 37;
the fifth user 35 has already performed at least one transaction with the first user 31, the second user 32, the sixth user 36, a twelfth user 312 and a fourteenth user 314;
the sixth user 36 has already performed at least one transaction with the second user 32 and the fifth user 35;
the seventh user 37 has already performed at least one transaction with the third user 33, the fourth user 34, the eighth user 38 and the twelfth user 312;
the eighth user 38 has already performed at least one transaction with the third user 33, the seventh contact 37, a ninth user 39 and an eleventh user 311;
the ninth user 39 has already performed at least one transaction with the eighth user 38, a tenth user 310, an eleventh user 311, the twelfth user 312, and a thirteenth user 313;
the tenth user 310 has already performed at least one transaction with the ninth user 39 and the eleventh user 311;
the eleventh user 311 has already performed at least one transaction with the eighth user 38, the ninth user 39 and the tenth user 310;
the twelfth user 312 has already performed at least one transaction with the fifth user 35, the seventh user 37, the ninth user 39, the thirteenth user 313, the fourteenth user 314 and a fifteenth user 315;
the thirteenth user 313 has already performed at least one transaction with the ninth user 39, the twelfth user 312 and the fifteenth user 315;
the fourteenth user 3₁₄ has already performed at least one transaction with the fifth user 3₅, the twelfth user 3₁₂ and the fifteenth user 3₁₅;
the fifteenth user 315 has already performed at least one transaction with the twelfth user 312, the thirteenth user 313 and the fourteenth user 314.

The dotted lines between the user 1 and the user 3₁, the user 3₄ and the user 3₇ represent NOK transactions, i.e. communications that has not been approved by the respective users 3₁, 3₄, 3₇.

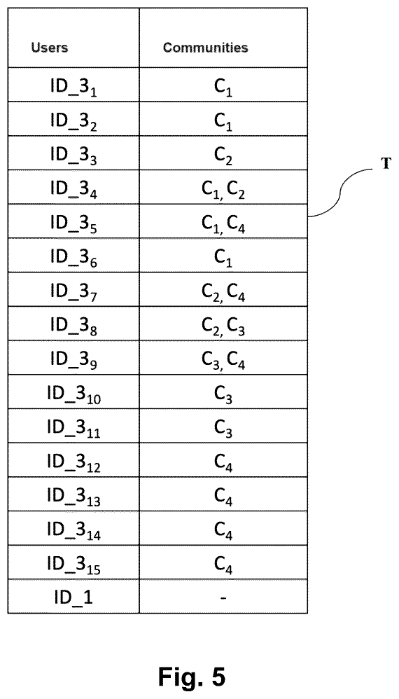

FIG. 5 shows a table T listing, for each user 3₁ to 3₁₅, the membership communit(y/ies). Users belong to the same community because they share at least one common interest (members of the same family, colleagues of a company or a group of companies, students of the same university circle, members of a sports governing body, etc.) or relationships leading them to communicate in various forms. Thus, this community forms a sphere of trust. A same user 3₁ to 3₁₅ may belong to several communities. The construction of these communities is based on a set of algorithms of the prior art modified and optimized so as to adapt to the structure, to the data volume and to the application context. The communities are represented in the table T by community identifier Cⱼ, where 1≤j≤4 in the illustrated example. In this table T, it is thus possible to deduce the following information:
the user 3₁ belongs to a first community C₁;
the user 3₂ belongs to the first community C₁;
the user 3₃ belongs to a second community C₂;
the user 3₄ belongs to the first community C₁ and to the second community C₂;
the user 3₅ belongs to the first community C₁ and to a fourth community C₄;
the user 3₆ belongs to the first community C₁;
the user 3₇ belongs to the second community C₂ and to the fourth community C₄;
the user 3₈ belongs to the second community C₂ and to the third community C₃;
the user 3₉ belongs to the third community C₃ and to the fourth community C₄;
the user 3₁₀ belongs to the third community C₃;
the user 3₁₁ belongs to the third community C₃;
the user 3₁₂ belongs to the fourth community C₄;
the user 3₁₃ belongs to the fourth community C₄;
the user 3₁₄ belongs to the fourth community C₄;
the user 3₁₅ belongs to the fourth community C₄.

It should be noted that, at this level, the user 1 does not belong to any community.

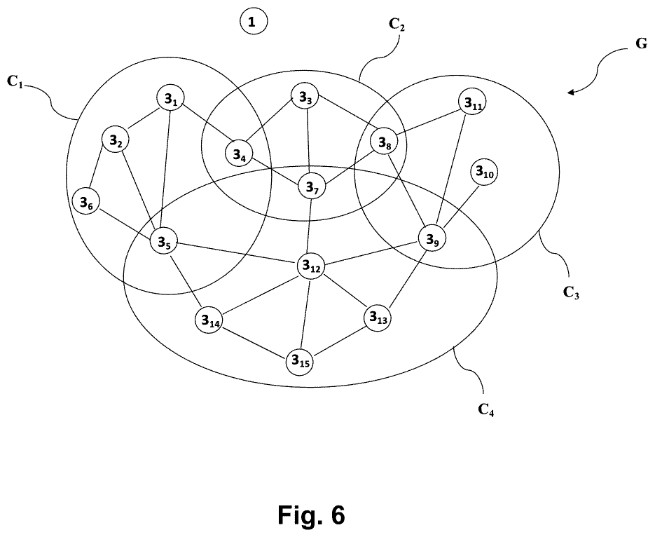

FIG. 6 illustrates a grouping of the users 3₁ to 3₁₅ of the graph G of FIG. 4, over which the different communities C₁ to C₄ are positioned. Each community is materialized by a generally circular shape surrounding the users belonging to said community. Thus, as already set out, the user 3₁, the user 3₂, the user 3₄, the user 3₅, the user 3₆ belong to the first community C₁. The user 3₃, the user 3₄, the user 3₇ and the user 3₈ belong to the second community C₂. The user 3₈, the user 3₉, the user 3₁₀ and the user 3₁₁ belong to the third community C₃. The user 3₅, the user 3₇, the user 3₉, the user 3₁₂, the user 3₁₃, the user 3₁₄ and the user 3₁₅ belong to the fourth community C₄.

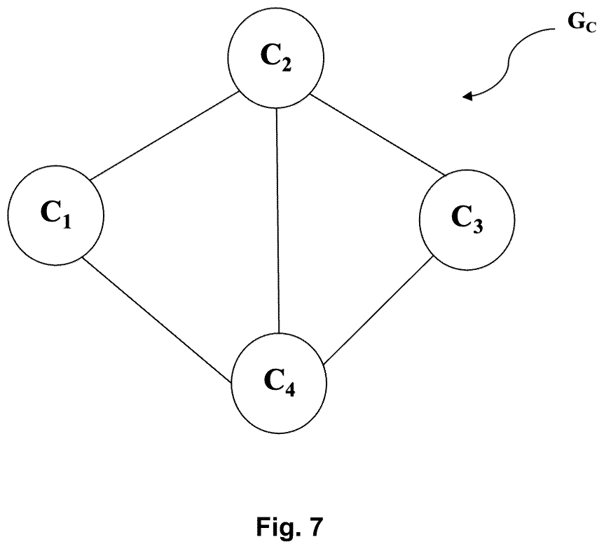

The different communities C₁ to C₄ may be perceived as a community graph including nodes and arcs linking said nodes. Such a community graph, referenced G_{C}, is illustrated in FIG. 7. Thus, each node corresponds to one community. The nodes are connected together when there is at least one common user between the communities. In the case of the community graph G_{C} of FIG. 7, there is an arc between the node associated with the first community C₁ and the node associated with the second community C₂, because the user 3₄ is common to the two communities. In the same manner, there is an arc between the node associated with the first community C₁ and the node associated with the fourth community C₄ because the user 3₅ is common to the two communities C₁ and C₄. In addition, there is an arc between the node associated with the second community C₂ and the node associated with the third community C₃ because the user 3₈ is common to the two communities C₂ and C₃. Furthermore, there is an arc between the node associated with the second community C₂ and the node associated with the fourth community C₄ because the user 3₇ is common to the two communities C₂ and C₄. Finally, there is an arc between the node associated with the third community C₃ and the node associated with the fourth community C₄ because the user 3₉ is common to the two communities C₃ and C₄.

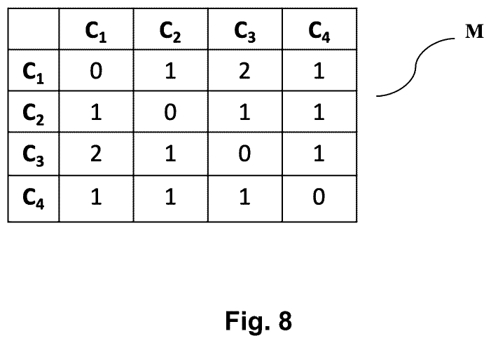

From the community graph G_{C}, it is possible to construct a matrix M for storing the minimum distance between the different communities. In particular, such a matrix M is illustrated in FIG. 8. This matrix M contains integer values comprised between 0 and 2. The value 0 is associated with a zero distance. The value 1 is associated with a distance between two communities connected by an arc, such as the community pairs C₁, C₂; C₁, C₄; C₂, C₃; C₂, C₄; C₃, C₄. The value 2 is assigned when an intermediate community connects two communities which have no arc in common, such as for example the community pair C₁, C₃ connected either by the second community C₂, or by the fourth community C₄. The distance storage matrix M is stored in the communication base 302.

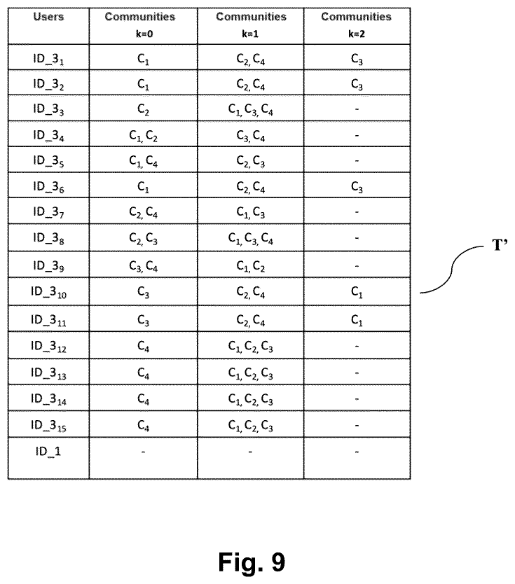

FIG. 9 shows a variant of a table T′ corresponding to an extension of the table T of FIG. 5. In this table T′, different neighborhood levels k are determined for each user of the aforementioned communities. The neighborhood level k=0 corresponding to the neighborhood level detailed in FIG. 5. The neighborhood level k=1 corresponds to a level of direct proximity with the communit(y/ies) of the neighborhood level k=0. The neighborhood level k=2 corresponds to a level of direct proximity with the communit (y/ics) of the neighborhood level k=1. Thus, for example, the neighborhood level k=0 of the user 3₁ comprises the first community C₁. The neighborhood level k=1 for this same user comprises the second community C₂ and the fourth community C₄. Finally, the neighborhood level k=2 for this same user comprises the third community C₃. Still for example, the neighborhood level k=0 of the user 3₃ comprises the community C₂. The neighborhood level k=1 for this same user comprises the community C₁, the community C₃ and the community C₄. Finally, the neighborhood level k=2 for this same user does not comprise any community.

As illustrated in FIG. 1, the communication base 302 is updated by the supervision device S. This supervision device S is adapted to listen to the communication network R and to detect any transaction between i users 3₁ to 3₁₅, where 1≤i≤15 in the illustrated example. The supervision device S is also adapted to detect the communication requests originating from the user 1. The supervision device S periodically updates the communication history H, the table T listing the communities C₁ to C₄, the table T′ and the matrix M for storing the minimum distance.

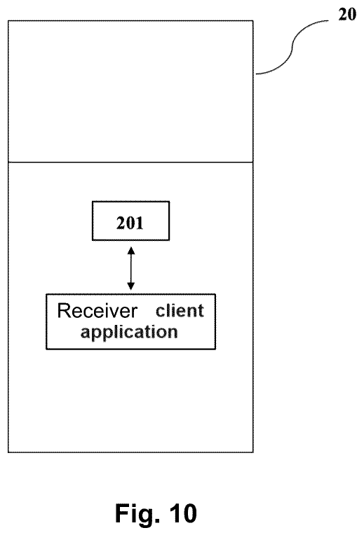

The terminal 20 of the user 2 is adapted to receive the data Data associated with the determination of the trust score and of the trust deviation Deltaconf. In particular, such a terminal 20 is illustrated in FIG. 10. It comprises:
a receiver client application;
an interface module 201.

The receiver client application is adapted to receive and process the data Data.

The interface module 201 is adapted to render the result of this processing to the user 2 on a dedicated interface of the terminal 20 or of another terminal.

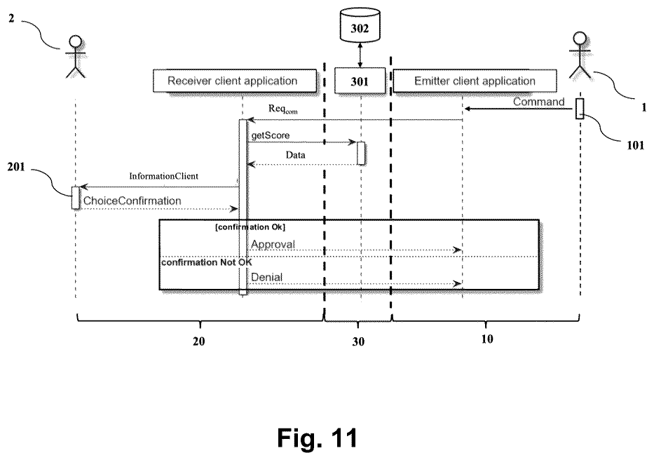

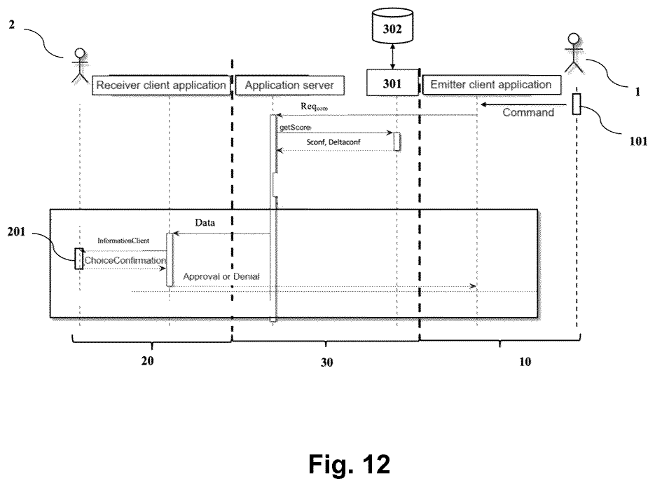

Depending on the type of the terminal 20, the processing made on the data Data will not be the same. FIG. 11 illustrates the steps of a decision-making assist method according to a first embodiment, wherein a terminal 20, which is the addressee of the communication request Req_{com}, is a “smartphone” or smart terminal. FIG. 12 illustrates the steps of a decision-making assist method, according to a second embodiment, wherein the terminal 20 has lower capabilities than the terminal 20 used in the method of FIG. 11.

The decision-making assist method illustrated in FIG. 11 comprises transmitting a command Command by the user 1 via the interface module 101 from his/her terminal 10 to the emitter client application of this same terminal 10. Upon reception of this command, the emitter client application transmits a communication request Req_{com} to the receiver client application of the terminal 20 of the user 2. This request comprises an identifier ID_1 of the user 1. The receiver client application transmits to the computing device 301 a query getScore for determining a trust score Sconf of the user 1 and a trust deviation Deltaconf. This query getScore comprises the identifier ID_1 of the user 1. In return, the computing device 301 supplies the data Data to the receiver client application. These data Data herein consist of the trust score Sconf of the user 1 and the trust deviation Deltaconf. The computing device 301 determines these data Data by consulting the communication base 302. The trust score Sconf and the trust deviation Deltaconf may be determined by different methods.

### DETAILED DESCRIPTION OF CERTAIN ILLUSTRATIVE EMBODIMENTS

In a first method, the computing device 301 uses the information contained in the history H of FIG. 3, in the table T of FIG. 5 and in the matrix M of FIG. 8. From the history H, it is possible to establish a list h of user(s) to whom the emitter user 1 has transmitted beforehand a communication request, via his/her terminal 20. As already explained with reference to FIG. 3, this list h is as subset of the history H. In the example of FIG. 3, the user 1 has transmitted beforehand a communication request to the user 3₁, to the user 3₄ and to the user 3₇.

Each of these users 3₁, 3₄, 3₇ belongs to one community.

From the table T of FIG. 5, it is thus possible to define that:
the user 3₁ belongs to the community C₁ (first row of the table T);
the user 3₄ belongs to the communities C₁ and C₂ (fourth row of the table T);
the user 3₇ belongs to the communities C₂ and C₄ (seventh row of the table T).

From the users of the list h, pairs of contact users [3₁, 3₄], [3₁, 3₇] and [3₄, 3₇] are formed.

In each of the pairs of users, at least one minimum intercommunity distance D with D=Min (M(Cₘ, Cₙ)) is determined where m and n are integers herein comprised between 1 and 4. This minimum intercommunity distance is obtained by comparing the communities to which the users of the pair belong using the matrix M of FIG. 8.

Thus, in the pair [3₁, 3₄], a first distance is determined between the community C₁ of the user 3₁ and the community C₁ of the user 3₄ and a second distance between the community C₁ of the user 3₁ and the community C₂ of the user 3₄. In accordance with FIG. 8, the first distance is zero (intersection C₁-C₁ in the table T) and the second distance amounts to 1 (intersection C₁-C₂ in the table T). Henceforth, the minimum intercommunity distance is herein zero (the minimum between 0 and 1).

Said otherwise, D[3₁, 3₄]=Min (M(C₁, C₁), M(C₁, C₂))=Min (0, 1)=0.

In the same manner, for the pair [3₁, 3₇], D[3₁, 3₇]=Min (M(C₁, C₂), M(C₁, C₄))=Min (1, 1)=1.

For the pair [3₄, 3₇], D[3₄, 3₇]=Min (M(C₁, C₂), M(C₁, C₄), M(C₂, C₂), M(C₂, C₄))=Min (1, 1, 0, 1)=0.

The trust score Sconf corresponds to the average of the minimum intercommunity distances of the different pairs of users. Said otherwise, Sconf=Average (D[3₁, 3₄], D[3₁, 3₇], D[3₄, 3₇])=Average (0, 1, 0)=0.33.

The trust deviation Deltaconf corresponds to the standard deviation of the minimum intercommunity distances of the different pairs of users. Thus, Deltaconf=Standard deviation (D[3₁, 3₄], D[3₁, 3₇], D[3₄, 3₇]).

The deviations are herein determined with respect to the average 0.33. The standard deviation corresponds to the root mean square of these deviations, thereby

$$Deltaconf = √ \frac{( 0 , {33}^{2} + 0 , {67}^{2} + 0 , {33}^{2} )}{3} ,$$

namely 0.47.

In a second method for determining the trust score Sconf and the trust deviation Deltaconf, the computing device 301 uses the information contained in the history H of FIG. 3 and in the extended table T′ of FIG. 9. In the same manner as in the first method, from the history H, it is possible to establish a list h of user(s) to whom the user 1 has transmitted beforehand a communication request, via his/her terminal 20. In the example of FIG. 3, the user 1 has transmitted beforehand a communication request to the user 3₁, to the user 3₄ and to the user 3₇.

Each of these users 3₁, 3₄, 3₇ belongs to one community.

From the extended table T′ of FIG. 5, it is thus possible to define that:
the user 3₁ belongs to the community C₁ (first row of the table T for a neighborhood level k=0), the user 3₁ is neighbor of the community C₂ and of the community C₄ at a neighborhood level k=1 and the user 3₁ is neighbor of the community C₃ at a neighborhood level k=2;
the user 3₄ belongs to the communities C₁ and C₂ (fourth row of the table T for a neighborhood level k=0), the user 3₄ is neighbor of the community C₃ and of the community C₄ at a neighborhood level k=1;
the user 3₇ belongs to the communities C₂ and C₄ (seventh row of the table T for a neighborhood level k=0), the user 3₇ is neighbor of the community C₁ and of the community C₃ at a neighborhood level k=1.

From the users of the list h, pairs of users [3₁, 3₄], [3₁, 3₇] and [3₄, 3₇] are formed.

In each of the pairs of users, at least one minimum intercommunity distance D with D=Min (M (Cₘ′, Cₙ′)) is determined where m′ and n′ are integers herein comprised between 1 and 4. This minimum intercommunity distance is obtained by comparing the communities to which the users of the pair in the table T′ of FIG. 9 belong.

For the pair of users [3₁, 3₄], the community C₁ is common to the users 3₁ and 3₄. Henceforth, the minimum intercommunity distance D[3₁, 3₄] is zero.

For the pair of users [3₄, 3₇], the community C₂ is common to the users 3₄ and 3₇. Henceforth, the minimum intercommunity distance D[3₄, 3₇] is zero.

For the pair of users [3₁, 3₇], there is no common community at a neighborhood level k=0. However, the community C₁ is at a neighborhood level k=1 for the user 3₇. Henceforth, the minimum intercommunity distance D[3₁, 3₇] is equal to 1.

The trust score Sconf corresponds to the average of the minimum intercommunity distances of the different pairs of users. Said otherwise, Sconf=Average (D[3₁, 3₄], D[3₁, 3₇], D[3₄, 3₇])=Average (0, 1, 0)=0.33.

The trust deviation Deltaconf corresponds to the standard deviation of the minimum intercommunity distances of the different pairs of contact users. Thus, Deltaconf=Standard deviation (D[3₁, 3₄], D[3₁, 3₇], D[3₄, 3₇]).

The deviations are herein determined with respect to the average 0.33. The standard deviation is the root mean square of these deviations, thereby

$$Deltaconf = √ \frac{( 0 , {33}^{2} + 0 , {67}^{2} + 0 , {33}^{2} )}{3} ,$$

namely 0.47.

In a third method, the computing device 301 uses the information contained in the history H of FIG. 3, in the table T of FIG. 5 and in the matrix M of FIG. 8. From the history H, it is possible to establish a list h of user(s) to whom the user 1 has transmitted beforehand a communication request. As already set out, this list h is a subset of the history H. In the example of FIG. 3, the user 1 has transmitted beforehand a communication request to the user 3₁, to the user 3₄ and to the user 3₇.

Each of these users 3₁, 3₄, 3₇ belongs to one community.

Thus, from the table T of FIG. 5, it is possible to define that:
the user 3₁ belongs to the community C₁ (first row of the table T);
the user 3₄ belongs to the community C₁ and C₂ (fourth row of the table T);
the user 3₇ belongs to the community C₂ and C₄ (seventh row of the table T).

From the users of the list h, pairs of users [3₁, 3₄], [3₁, 3₇] and [3₄, 3₇] are formed.

The trust score Sconf herein corresponds to the cardinality of the union of the communities of the users.

Said otherwise, Sconf=| 3₁∪3₄∪3₇|=|[C₁]∪[C₁, C₂]∪[C₂, C₄]|=|[C₁, C₂, C₄]|. The cardinality of the union of the communities of the users is therefore herein equal to 3.

The trust deviation Deltaconf corresponds to the trust score Sconf from which is subtracted an average of cardinalities of the unions of the communities of the users.

Said otherwise, Deltaconf=| 3₁∪3₄∪3₇|−average (|3₁∪3₄|, |3₁∪3₇|, |3₄∪3₇|)=|[C₁, C₂, C₄]|−average (|[C₁, C₂]|, |[C₁, C₂, C₄]|, [C₁, C₂, C₄]|)=3−average (2, 3, 3)=0.33.

As already indicated, the receiver client application of FIG. 11 is adapted to process the trust score Sconf and the trust deviation Deltaconf determined by either one of the methods disclosed hereinabove. For this purpose, the receiver client application exploits a first threshold for the trust score and a second threshold for the trust deviation.

If the trust score determined by the computing device 301 is higher than the first threshold, this indicates that the user 2 is an abusive user using phishing, scam or spam type practices. In this kind of practice, the abusive user has a tendency to contact a very broad selection of users, which causes a divergence with respect to the normal (high average).

If the trust score determined by the computing device 301 is lower than the first threshold, the trust deviation Deltaconf is then compared with the second threshold. A “new entering” user logically has a tendency to contact legitimate users, well-established, having a strong social bond probability. By “legitimate” user, it should be understood a member known to the service which, by its conventional use, has a tendency to contact or be contacted by other users. Thus, a honest user 1 will orient his/her strategy of initial contact before several legitimate users, which will limit the deviations between the contacted users. The trust deviation Deltaconf will then be low. Conversely, an abusive user 1 will have an erratic strategy of initial contact by contacting both legitimate users and non-legitimate users, which will increase the deviations between the contacted users. The trust deviation Deltaconf will then be high and such a user 1 should be dismissed.

Upon completion of this processing, the receiver client application provides a decision-making assistance to the interface module 201 in the form of a piece of information InformationClient. This information indicates to the user 2 whether he/she can or cannot approve the communication request Req_{com} originating from the user 1.

The user 2 indicates his/her choice (ChoiceConfirmation in FIG. 11) to the receiver client application via the interface module 201. If the communication with the user 1 is approved (confirmation OK in FIG. 11), a notification of approval of the request Req_{com} (Approval in FIG. 11) is sent to the emitter client application. Conversely, if the communication with the user 1 is denied (Confirmation Not OK in FIG. 11), a notification of denial of the request Req_{com} (Denial in FIG. 11) is sent to the emitter client application.

It should be noted that the supervision device S updates the communication base 302 depending on the decision of the user 2.

The decision-making assist device 30 used in the method of FIG. 12 is different in that it has an additional application server. This application server is adapted to directly process the trust score Sconf and the trust deviation Deltaconf determined by the computing device 301. Thus, such a processing is no longer carried out within the receiver terminal 20 like in the embodiment of FIG. 11.

The method of FIG. 12 comprises the transmission of a command Command by the user 1 via the interface module 101 of the emitter client application terminal 10 of this same terminal 10. Upon reception of this command, the emitter client application transmits a communication request Req_{com} to the application server of the device 30. This request comprises the identifier ID_1 of the user 1. The application server transmits to the computing device 301 a query getScore for determining a trust score Sconf of the user 1 and a trust deviation Deltaconf. This query getScore comprises the identifier ID_1 of the user 1. In return, the computing device 301 supplies to the application server the trust score Sconf of the user 1 and the trust deviation Deltaconf. The computing device 301 determines these data Data by consulting the communication base 302. The trust score Sconf and the trust deviation Deltaconf may be determined by the different methods disclosed before.

The application server is able to process the trust score Sconf and the trust deviation Deltaconf and to provide a decision-making assistance to the receiver client application by the transmission of these data Data to this application. The receiver client application adapts the client information to the interface module 201. The client information indicates to the user 2 whether he/she can, or cannot, approve the communication request Req_{com} originating from the user 1. The user 2 indicates his/her choice (ChoiceConfirmation in FIG. 12) to the receiver client application, via the interface module 201. If the communication with the user 1 is approved, an approval notification (Approval in FIG. 12) is sent to the emitter client application. Conversely, if the communication with the emitter user is denied, a notification of denial (Denial in FIG. 12) is sent to the emitter client application.

Thus, the decision-making assistance may be applied to different cases of use.

A first case of use of the development relate to “mobile banking/SMShing”. The users of “mobile banking” applications are often victims of scam attempts intended to divert all or part of the funds towards one or more fraudulent account(s) in a more or less tricky way. Fraud or scam attempts are numerous and various but often replicate a classical scenario: a fraudster/scammer buys a temporary SIM card and proceeds, for a limited time, with a phishing campaign. He/She sends SMSs (or calls) to a large number of users randomly designated from client lists originating from data leaks from a merchant website (for example) or exchange/buy lists of phone numbers of potential targets. The content of the message (winning in a game, having an acquaintance in distress, etc.) incites the victim user to initiate a transaction towards an account that he/she believes “legitimate” but actually associated with the fraudster. The account will be used to collect a portion of the funds of the fraud campaign and will then be closed after having been emptied. The numerous victims targeted by this campaign do not know each other and have no strong “social” bonds with each other. In addition, these victims are installed in the system (present on sold or exchanged lists). The probability that x victims randomly selected by the algorithm among N (on the lists) could have a computable (and short) community social distance is low, and even almost zero. Hence, the abusive behavior of the fraudster can be qualified and quantified rapidly (from a few transactions) and could be presented to the victims as of the first exchanges upon reception of the call or of the SMS (standing for “Short Message System” in English), or upon sending of the transaction.

A second case of use relates to “communication/canvassing”.

During a phone canvassing campaign, companies use several call numbers that are renewed very often. Some applications of the prior art offer to the canvassing victims to identify and qualify the canvassing type (commercial, malicious) in a collaborative manner and offers a solution for sharing this information via the application. Several hours/days might pass before the service becomes fully effective (enough reports) and leave time to the companies to modify their call number. Based on the same principle as described for the first case, the canvassers exploit lists of numbers to call, the “victims” present on these lists a priori have no bonds with each other and therefore a low (and even almost zero) probability, the average social distance is very long (with infinite distances).

A third case of application relates to “scam e-mail/spam” management. When a user of an electronic mail service receives an incoming communication (an e-mail) from an “unknown” emitter, the development allows computing an a priori abusive use of the emitter of the e-mail, such as scam or spam emitters. The computing device 301 could then exploit this score in order to classify the e-mails, and even discard them, in an optimized manner: the emitters having a high score will a priori be spam emitters, the emitters having an average score will be corporate/institution emitters, and the emitters having low scores will be individuals. The receiver user could then contact the computing device 301 in order to consult these different e-mails, putting forward the e-mails of legitimate users, and filtering spams and scam e-mails.

The solution proposed by the development is also applicable to any context implementing transaction, incoming or outgoing, for which it is possible to establish a social relationship between the actors of the system: mobile payments, bank transfers, communication (e-mails, phone calls, sms, CDR (standing for “Call Detail Record” in English), etc.).

The development allows displaying, in real-time, the trust level of each incoming transaction at the terminal 20.

The proposed development is complementary of the solutions described in the prior art and enhances their effectiveness.

Thus, the proposed solution is based on the use of a software module for controlling and securing the transaction.

In a particular embodiment, the development is based on a practice based on “scoring” an average social distance between the contacts of an emitter user of a communication request, to extract therefrom a trust score assessing his/her virtuous integration/use of the communication service. This trust score is a criterion assessing, for each transaction emitter, his/her predisposition to disseminate personal/relevant/generic information or on the contrary information that is detrimental towards his/her interlocutors.

On the basis of a software module that allows constructing sets of users identified as having a transactional social proximity calculated on the basis of the past exchanges, all users, and their past transactions, form a network, each node of which is a user, and the past transactional data allow creating a relationship between the nodes of the network.

The proposed system assigns one or more membership communit(y/ies) to each user.

For each user, the system stores his/her computed set of membership communities and keeps him/her up-to-date through an automated procedure applied on a regular basis (once a day/month/week).

To this information, it should be added the trust deviation computed by the method of the development. In one embodiment, this trust deviation is computed from minimum intercommunity distances. In another embodiment, the trust deviation is determined from a cardinality of a union of user communities.

What is claimed is:

1. A decision-making assist method for a user of a first terminal receiving a communication request originating from a second terminal, the user of the second terminal still not having transmitted any communication request to the user of the first terminal, the method comprising:
determining a trust score of the user of the second terminal and a trust deviation, the trust deviation providing information on a reliability of the trust score, the trust score and the trust deviation being determined from a list comprising at least one user (3₁, 3₄, 3₇) of a third terminal to which the second terminal has already transmitted a communication request, the at least one user (3₁, 3₄, 3₇) of the third terminal belonging to at least one user community (C₁, C₂, C₄).

2. The decision-making assist method according to claim 1, wherein the list comprises three users (3₁, 3₄, 3₇) of respectively three terminals to which the second terminal has already transmitted a communication request.

3. The decision-making assist method according to claim 1, wherein the determination of the trust score and of the trust deviation comprises selecting at least one pair ([3₁, 3₄], [3₁, 3₇], [3₄, 3₇]) of users in the list.

4. The decision-making assist method according to claim 3, wherein the determination of the trust score comprises, for each pair ([3₁, 3₄], [3₁, 3₇], [3₄, 3₇]) of users, computing a minimum intercommunity distance (D[3₁, 3₄], D[3₁, 3₇], D[3₄, 3₇]), the minimum intercommunity distance being determined from community sets (C₁, C₂, C₄) to which the users of the pair belong, the trust score corresponding to an average of the minimum intercommunity distances (D[3₁, 3₄], D[3₁, 3₇], D[3₄, 3₇]) of the pairs ([3₁, 3₄], [3₁, 3₇], [3₄, 3₇]).

5. The decision-making assist method according to claim 4, wherein the minimum intercommunity distance of a pair is zero when the users of the pair have one community in common.

6. The decision-making assist method according to claim 4, wherein the minimum intercommunity distance of a pair is at least equal to 1 when the users of the pair have no community in common.

7. The decision-making assist method according to claim 4, wherein the trust deviation corresponds to a standard deviation of the minimum intercommunity distances (D[3₁, 3₄], D[3₁, 3₇], D[3₄, 3₇]) of the pairs ([3₁, 3₄], [3₁, 3₇], [3₄, 3₇]).

8. The decision-making assist method according to claim 2, wherein the trust score corresponds to a cardinality of a union of user communities to which the three users of the list belong.

9. The decision-making assist method according to claim 8, wherein the trust deviation corresponds to the trust score from which is subtracted an average of the cardinalities of unions of the user communities to which the three users of the list belong.

10. A decision-making assist system for a user of a first terminal receiving a communication request originating from a second terminal, the user of the second terminal still not having transmitted any communication request to the user of the first terminal, the decision-making assist system comprising a computing device and a communication base, the computing device and the communication base being able to determine a trust score of the user of the second terminal and a trust deviation, the trust deviation providing information on a reliability of the trust score, the trust score and the trust deviation being determined from a list comprising at least one user (3₁, 3₄, 3₇) of a third terminal to which the second terminal has already transmitted a communication request, the at least one user (3₁, 3₄, 3₇) of the third terminal belonging to at least one user community (C₁, C₂, C₄).

11. The decision-making assist system according to claim 10, wherein the computing device is adapted to transmit the trust score and the trust deviation to the first terminal.

12. The decision-making assist system according to claim 11, wherein the system comprises an application server, the application server being able to process the trust score and the trust deviation and to send the result of the processing to the first terminal.

13. A processing circuit comprising a processor and a memory, the memory storing program code instructions of a computer program to execute the decision-making assist method according to claim 1, when the computer program is executed by the processor.

14. A non-transitory computer-readable recording medium on which a computer program is recorded comprising program code instructions for execution of the decision-making assist method according to claim 1, when the computer program is executed by a processor.
